(19) United States
(12) Patent Application Publication
(10) Pub. No.: US 2012/0310893 A1
(43) Pub. Date: Dec. 6, 2012

(54) SYSTEMS AND METHODS FOR MANIPULATING AND ARCHIVING WEB CONTENT

(76) Inventors: Ben Wolf, Middleton, WI (US); Jim Fiorato, Wheaton, IL (US); Rakesh Madhava, Chicago, IL (US)

(21) Appl. No.: 13/151,226

(22) Filed: Jun. 1, 2011

(51) Int. Cl. G06F 17/30

(52) U.S. Cl. 707/661; 707/E17.005; 707/E17.044

(57) ABSTRACT

Systems and methods for manipulating and archiving web content. A uniform resource locator (URL) associated with a network resource is obtained. A virtual copy of the network resource is rendered by accessing the network resource and associated resources using the URL, where the associated resources include presentation data. A client-side representation of the network resource is stored based on the rendering of the virtual copy of the network resource. At least one irrelevant data pattern in the virtual copy of the network resource is identified. The virtual copy of the network resource is manipulated by applying client-side scripting language code to remove irrelevant data associated with the at least one irrelevant data pattern. One or more linked URLs present in the virtual copy of the network resource are recursively processed.

### BACKGROUND OF THE INVENTION

1. Field of the Invention

Embodiments of the systems and methods described herein pertain to the field of computer systems. More particularly, but not by way of limitation, one or more embodiments described herein enable systems and methods for manipulating and archiving web content.

2. Description of the Related Art

Electronic data presents unique issues in terms of archiving, versioning and storage of data. For almost all of modern history, published information existed in a physical and immutable form. As long as the physical form was not destroyed, lost, damaged or purposefully modified, the existence of such data could be relied on for compliance, record-keeping and other purposes.

Today, the transient nature of electronic data presents new challenges regarding the preservation of content. With the growing availability of channels to publish information, the amount of electronic data is rapidly growing. The Internet is a major source of publicly available electronic data. Such data can be easily added, removed and modified. However, there is no default method for assuring that such changes are tracked.

Currently web archives exist that claim to provide an archive of web pages. Such archives were created by crawling Internet resources. Archives may be restricted to resources linked to a URL, resources within a domain, up to archives spanning the entire Internet. However, these archives are often incomplete due to the vast amount of data to cover and the rate at which data changes. Storage space limits the frequency and amount of data that can be stored. Furthermore, because network resources are frequently changing, many web pages attempt to incorporate associated resources that no longer exist, resources that have been modified, resources that cannot be accessed with the archived web language, or resources that do not exist in the archive.

Furthermore, electronic data is increasingly presented in combinations that make it difficult to distinguish new or modified content from unchanged content. Advertisements, data feeds, rotating content, metadata and other types of irrelevant data may cause a web archiving application to incorrectly determine that web content has changed. An incorrect decision to archive content based on a change in irrelevant data wastes processing resources and storage resources. Therefore, the amount of data archived and/or the frequency of archiving is compromised.

Rules and regulations on published data are present in industry, government agencies, statutes, and other places. Because of these difficulties present in electronic data, there are challenges in complying with rules and regulations for record and data keeping. Nevertheless, compliance with such rules and regulations is often required whether data is in paper or electronic form. For example, with the advent and popularization of social media, regulated corporations are actively engaging in social media marketing as a central strategy in engaging the public.

There is a need for a system and method for manipulating and archiving web content to overcome the problems and limitations described above.

### BRIEF SUMMARY OF THE INVENTION

Systems and methods for manipulating and archiving web content are provided that store an accurate client-side representation of web content as it was intended to appear to the intended audience accessing the web content in a browser. Furthermore, systems and methods for manipulating and archiving web content are provided that allow the use of client-side scripting language to manipulate web content for customization purposes, comparison purposes and archival purposes. Web content can be manipulated to remove irrelevant data and to prevent storing unnecessary versions of web content with irrelevant changes.

Systems and methods for manipulating and archiving web content are provided that provide persistent data storage and archival suitable for compliance with one or more rules and regulations, including but not limited to industry and/or agency regulations. An application is also provided for accessing and modifying archived web content. Furthermore, systems and methods for manipulating and archiving web content are provided that utilize parallel web page crawling.

Systems and methods for manipulating and archiving web content include customizable applications that provide electronic document management solutions that enable marking, modification, and transfer of archived content. Such customizable applications include applications that are compliant with one or more rules and regulations, including but not limited to industry and/or agency regulations. Customizable applications may also be suitable for e-discovery, record management, employee management, managing social media, and any other purpose that is compatible with systems and methods for manipulating and archiving web content.

One or more embodiments of systems and methods for manipulating and archiving web content are directed to a computer-readable medium for archiving modified web content including computer-readable instructions, where execution of the computer-readable instructions by one or more processors causes the one or more processors to carry out steps including obtaining a uniform resource locator (URL) associated with a network resource.

In one or more embodiments of the computer-readable medium for archiving modified web content, the steps include rendering a virtual copy of the network resource by accessing the network resource and associated resources using the URL, where the associated resources include presentation data. In one or more embodiments, the associated resources include scripting language code associated with the network resource. The virtual copy of the network resource may be rendered in a virtual browser.

In one or more embodiments of the computer-readable medium for archiving modified web content, the steps include storing a client-side representation of the network resource based on the rendering of the virtual copy of the network resource. In one or more embodiments, the client-side representation is a flattened file. The client-side representation may be a screenshot of the network resource as presented to a client accessing the URL.

In one or more embodiments of the computer-readable medium for archiving modified web content, the steps include identifying at least one irrelevant data pattern in the virtual copy of the network resource.

In one or more embodiments of the computer-readable medium for archiving modified web content, the steps include manipulating the virtual copy of the network resource by applying client-side scripting language code to remove irrelevant data associated with the at least one irrelevant data pattern. The client-side scripting language code may be dynamically obtained. In one or more embodiments, the client-side scripting language code is JavaScript code. The client-side scripting language code may be applied in a virtual browser.

In one or more embodiments of the computer-readable medium for archiving modified web content, the steps include optionally storing the virtual copy of the network resource.

In one or more embodiments of the computer-readable medium for archiving modified web content, the steps include recursively processing one or more linked URLs present in the virtual copy of the network resource. In one or more embodiments, the recursively processing one or more linked URLs terminates based on a link distance from one or more specified domain names.

In one or more embodiments of the computer-readable medium for archiving modified web content, recursively processing the one or more linked URLs includes processing at least one of the one or more linked URLs on two or more virtual machines. The one or more linked URLs may be processed in parallel by the two or more virtual machines. In one or more embodiments, the two or more virtual machines include a plurality of virtual machines in a cloud computing environment. A total number of the plurality of virtual machines may be limited to control a volume of traffic targeted at one or more domains associated with the URL.

In one or more embodiments of the computer-readable medium for archiving modified web content, the client-side representation is stored before applying the client-side scripting language code. The representation of the network resource may be stored after manipulating the virtual copy of the network resource.

In one or more embodiments of the computer-readable medium for archiving modified web content, the steps further include determining if the network resource has been modified since a prior virtual copy of the network resource was processed, where storing the representation of the network resource includes storing current time information and associating the current time information with the prior virtual copy of the network resource when the network resource has not been modified since the prior virtual copy of the network resource was processed. In one or more embodiments, determining if the network resource has been modified includes determining if the prior virtual copy of the network resource is identical to the virtual copy of the network resource after the manipulating.

In one or more embodiments of the computer-readable medium for archiving modified web content, the manipulating does not remove any data required for compliance with one or more regulatory bodies.

In one or more embodiments of the computer-readable medium for archiving modified web content, the steps further include providing a user interface to display one or more stored network resource representations, accepting at least one modification to the one or more stored network resource representations from a user through the user interface, and storing the at least one modification in association with the one or more stored network resource representations. In one or more embodiments, the at least one modification includes one or more redactions. The at least one modification may include adding at least one of a classification and a control number.

In one or more embodiments of the computer-readable medium for archiving modified web content, the steps further include identifying at least a section of the network resource as a social media source, identifying a presentation portion of the section of the network resource, and identifying a content portion of the section of the network resource. In one or more embodiments, storing the representation of the network resource includes storing the content portion of the section of the network resource without storing the presentation portion of the network resource.

One or more embodiments of systems and methods for manipulating and archiving web content are directed to a computer-implemented method for manipulating and archiving web content including the step of obtaining a uniform resource locator (URL) associated with a network resource.

In one or more embodiments of the computer-implemented method for archiving modified web content, the steps further include rendering a virtual copy of the network resource in a virtual browser by accessing the network resource and associated resources over a network using the URL.

In one or more embodiments of the computer-implemented method for archiving modified web content, the steps further include storing a client-side representation of the network resource based on the rendering of the virtual copy of the network resource, where the client-side representation is stored in a computer-readable storage medium.

In one or more embodiments of the computer-implemented method for archiving modified web content, the steps further include manipulating the virtual copy of the network resource in the virtual browser with JavaScript code.

In one or more embodiments of the computer-implemented method for archiving modified web content, the steps further include optionally storing the virtual copy of the network resource.

In one or more embodiments of the computer-implemented method for archiving modified web content, the steps further include recursively processing one or more linked URLs present in the virtual copy of the network resource. In one or more embodiments, recursively processing the one or more linked URLs includes processing a plurality of the one or more linked URLs on a plurality of virtual machines in parallel in a cloud computing environment.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates a general-purpose computer and peripherals that when programmed as described herein may operate as a specially programmed computer capable of implementing one or more systems and methods for manipulating and archiving web content.

FIG. 2 is a diagram of an exemplary system in accordance with systems and methods for manipulating and archiving web content.

FIG. 3 illustrates an exemplary recursive process in accordance with systems and methods for manipulating and archiving web content.

FIG. 4 illustrates an exemplary recursive process using virtual machines in accordance with systems and methods for manipulating and archiving web content.

FIG. 5 illustrates an exemplary recursive process involving JavaScript manipulation in accordance with systems and methods for manipulating and archiving web content.

FIG. 6 illustrates an exemplary user interface for displaying stored network resource representations in accordance with systems and methods for manipulating and archiving web content.

### DETAILED DESCRIPTION

Systems and methods for manipulating and archiving web content will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the systems and methods described.

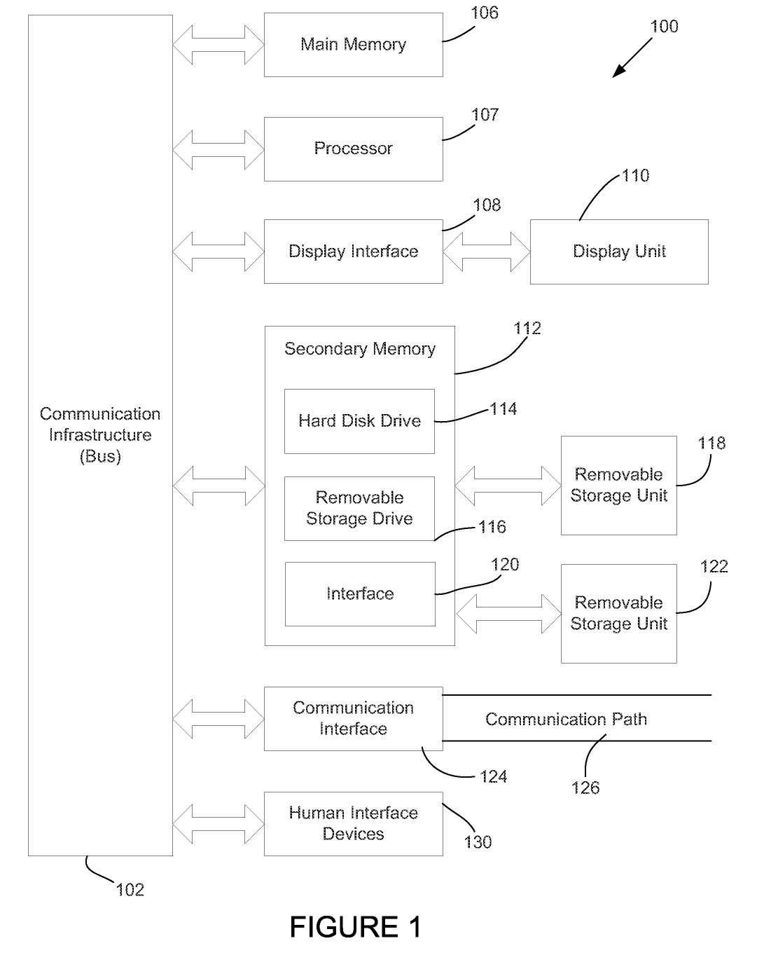

FIG. 1 diagrams a general-purpose computer and peripherals, when programmed as described herein, may operate as a specially programmed computer capable of implementing one or more systems and methods for manipulating and archiving web content. Processor 107 may be coupled to bi-directional communication infrastructure 102 such as communication infrastructure system bus 102. Communication infrastructure 102 may generally be a system bus that provides an interface to the other components in the general-purpose computer system such as processor 107, main memory 106, display interface 108, secondary memory 112 and/or communication interface 124.

Main memory 106 may provide a computer readable medium for accessing and executed stored data and applications. Display interface 108 may communicate with display unit 110 that may be utilized to display outputs to the user of the specially-programmed computer system. Display unit 110 may comprise one or more monitors that may visually depict aspects of the computer program to the user. Main memory 106 and display interface 108 may be coupled to communication infrastructure 102, which may serve as the interface point to secondary memory 112 and communication interface 124. Secondary memory 112 may provide additional memory resources beyond main memory 106, and may generally function as a storage location for computer programs to be executed by processor 107. Either fixed or removable computer-readable media may serve as Secondary memory 112. Secondary memory 112 may comprise, for example, hard disk 114 and removable storage drive 116 that may have an associated removable storage unit 118. There may be multiple sources of secondary memory 112 and systems implementing the solutions described in this disclosure may be configured as needed to support the data storage requirements of the user and the methods described herein. Secondary memory 112 may also comprise interface 120 that serves as an interface point to additional storage such as removable storage unit 122. Numerous types of data storage devices may serve as repositories for data utilized by the specially programmed computer system. For example, magnetic, optical or magnetic-optical storage systems, or any other available mass storage technology that provides a repository for digital information may be used.

Communication interface 124 may be coupled to communication infrastructure 102 and may serve as a conduit for data destined for or received from communication path 126. A network interface card (NIC) is an example of the type of device that once coupled to communication infrastructure 102 may provide a mechanism for transporting data to communication path 126. Computer networks such Local Area Networks (LAN), Wide Area Networks (WAN), Wireless networks, optical networks, distributed networks, the Internet or any combination thereof are some examples of the type of communication paths that may be utilized by the specially program computer system. Communication path 126 may comprise any type of telecommunication network or interconnection fabric that can transport data to and from communication interface 124.

To facilitate user interaction with the specially programmed computer system, one or more human interface devices (HID) 130 may be provided. Some examples of HIDs that enable users to input commands or data to the specially programmed computer may comprise a keyboard, mouse, touch screen devices, microphones or other audio interface devices, motion sensors or the like, as well as any other device able to accept any kind of human input and in turn communicate that input to processor 107 to trigger one or more responses from the specially programmed computer are within the scope of the system disclosed herein.

While FIG. 1 depicts a physical device, the scope of the system may also encompass a virtual device, virtual machine or simulator embodied in one or more computer programs executing on a computer or computer system and acting or providing a computer system environment compatible with the methods and processes of this disclosure. In one or more embodiments, the system may also encompass a cloud computing system or any other system where shared resources, such as hardware, applications, data, or any other resource are made available on demand over the Internet or any other network. Where a virtual machine, process, device or otherwise performs substantially similarly to that of a physical computer system, such a virtual platform will also fall within the scope of disclosure provided herein, notwithstanding the description herein of a physical system such as that in FIG. 1.

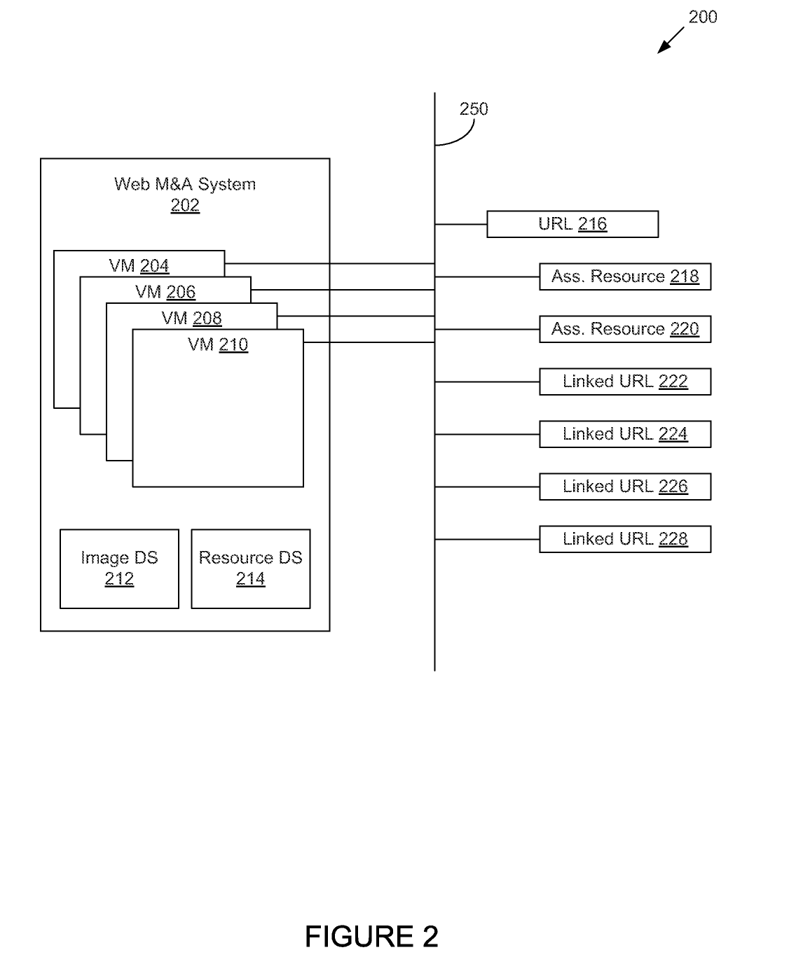

FIG. 2 is a diagram of an exemplary system in accordance with systems and methods for manipulating and archiving web content. System 200 includes web manipulation and archival system (Web M&A System) 202. Web M&A System 202 is configured to access, manipulate and archive a network resource via uniform resource locator (URL) 216 and its associated resources 218-220. Web M&A System 202 is also configured to recursively access, manipulate and archive network resources via linked URLs 222-228 and their associated web resources.

In one or more embodiments, Web M&A System 202 includes virtual machines 204-210. Virtual machines 204-210 are configured to access network resources over network 250. Network 250 may include one or more Local Area Networks (LAN), Wide Area Networks (WAN), Wireless networks, optical networks, distributed networks, the Internet or any combination thereof. Web M&A System 202 may be configured to manage the creation of virtual machines 204-210 and the tasks performed virtual machines 204-210. In one or more embodiments, a virtual machine may be assigned multiple URLs to process concurrently, assigned a single URL to process at once, or assigned a plurality of URLs to process in series, or any combination thereof. In one or more embodiments, a plurality of virtual machines 204-210 are employed in a cloud computing environment. In one or more embodiments, a total number of virtual machines 204-210 is limited to control a volume of traffic targeted at one or more domains associated with URL 216.

In one or more embodiments, virtual machines 204-210 are configured to process linked URLs 222-228 in parallel. Virtual machines 204-210 may be generated to handle an unprocessed linked URL. After a linked URL is processed by a virtual machine, the virtual machine may wait for another unprocessed linked URL or alternatively terminate.

For example, virtual machine 204 may first process an initial network resource via URL 216. The initial network resource includes linked URLs 222-228 and associated resources 218-220. Virtual machine 204 may also process associated resources 218-220 associated with the initial network resource. Web M&A System 202 may initiate virtual machines 206-210 to recursively process linked URLs 222-228 and any associated resources. In one or more embodiments, Web M&A System 202 may perform load balancing analysis to determine how to allocate processing power in virtual machines 204-210. Although virtual machines described herein are typically assigned network resources associated with a URL, any other network resources, may be assigned to a virtual machine without departing from the spirit or the scope of the invention.

In one or more embodiments, Web M&A System 202 includes image data store 212. In one or more embodiments, the client-side representation of the network resource is a flattened file. In one or more embodiments, virtual machines 204-210 are configured to store client-side representations of processed network resources associated with a URL in image data store 212. The client-side representations may include a flattened file, a screenshot, a PDF file, an image file, or any other client-side representation of a virtual copy of a network resource.

In one or more embodiments, Web M&A System 202 includes resource data store 214. In one or more embodiments, virtual machines 204-210 store processed components of processed network resources in resource data store 214. Resource data store 214 may include manipulated or unmanipulated copies of network resources. For example, resource data store 214 may include virtual copies of network resources manipulated using client-side scripting language code to remove irrelevant data.

Components of Web M&A System 202 may be implemented on a single computer or on multiple computers, such as computers connected over any network, including network 250. In one or more embodiments, components of Web M&A System 202 are implemented in a cloud computing environment.

Web M&A System 202 shown in FIG. 2 is a non-limiting exemplary configuration of systems and methods for manipulating and archiving web content. One of ordinary skill in the art would recognize that systems and methods for manipulating and archiving content include other embodiments described herein without departing from the spirit and the scope of the invention.

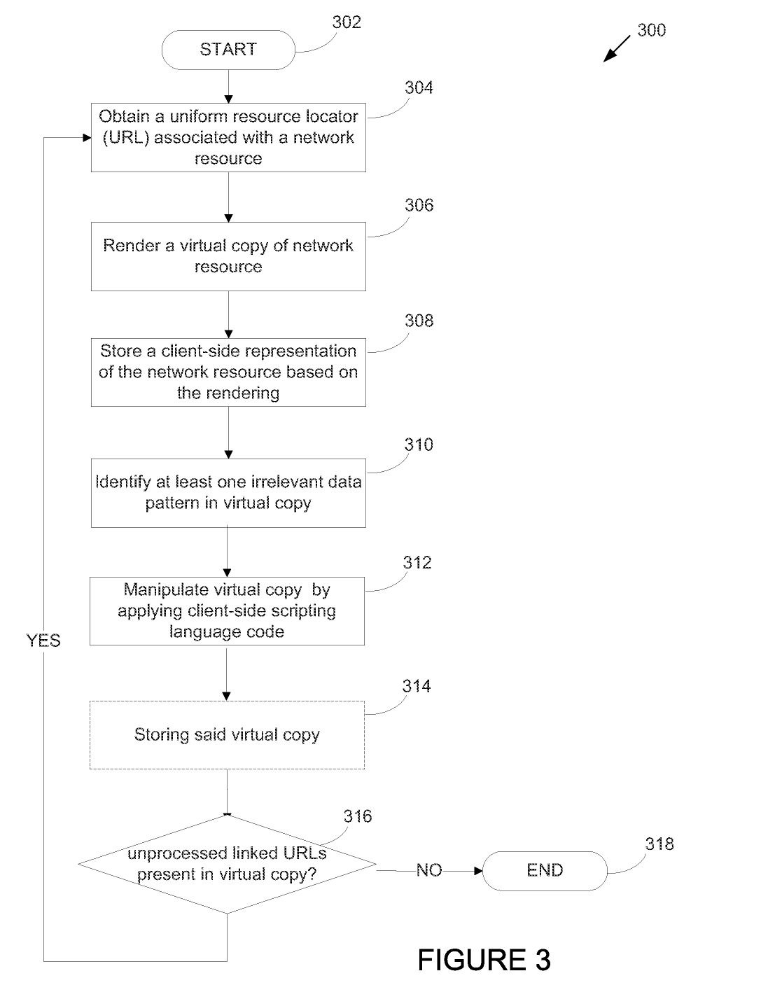

FIG. 3 illustrates an exemplary recursive process in accordance with systems and methods for manipulating and archiving web content. Process 300 starts at step 302.

Processing continues to step 304, where a uniform resource locator (URL) associated with a network resource is obtained. In one or more embodiments, the URL is associated with a webpage accessible over the Internet.

Processing continues to step 306, where a virtual copy of the network resource is rendered. The virtual copy of the network resource is rendered by accessing the network resource and associated resources using the URL. The associated resources may include presentation data.

In one or more embodiments, rendering the virtual copy of the network resource includes applying any presentation data to render a virtual copy of the network resource, where the rendering is designed to recreate the intended presentation of the network resource to the intended audience accessing the network resource via the URL.

In one or more embodiments, the associated resources include scripting language code associated with the network resource. In one or more embodiments, rendering the virtual copy of the network resource includes applying any scripting language code associated with the network resource, where the rendering is designed to recreate the intended presentation of the network resource to the intended audience accessing the network resource via the URL (e.g. in a browser).

In one or more embodiments, the virtual copy of the network resource is rendered in a virtual browser. As used herein, the term “virtual browser” refers to any application, program, or process configured to emulate the presentation of a network resource in a browser directed to the URL associated with the network resource. The virtual browser may be configured to render the virtual copy of the network resource to recreate the intended presentation of the network resource to the intended audience accessing the network resource via the URL using a browser, such as Microsoft Internet Explorer™, Google Chrome™, Mozilla Firefox™, Apple Safari™, Opera™ or any other web browser, including any general purpose or special purpose browser, such as a microbrowser or wireless Internet browser. For example, the virtual browser may be configured to apply scripting language code, use presentation data, integrate associated resources, and perform any other function to recreate the intended presentation of the network resource to the intended audience accessing the network resource via the URL using a browser. As used herein, the term “scripting language code” refers to any instructions written in any programming language that is capable of controlling an application without compiling the instructions to native machine code.

Processing continues to step 308, where a client-side representation of the network resource based on the rendering is stored. The client-side representation is generated based on the rendered virtual copy of the network resource. In one or more embodiments, the client-side representation is stored before manipulating the virtual copy of the network resource by applying the client-side scripting language code. In one or more embodiments, the client-side representation is stored after manipulating the virtual copy of the network resource by applying the client-side scripting language code.

In one or more embodiments, the step of rendering a client-side representation of the network resource includes determining if the network resource has been modified since a prior virtual copy of the network resource was processed. Determining if the network resource has been modified may include determining if the prior virtual copy of the network resource is identical to the virtual copy of the network resource after the manipulating by applying the client-side scripting language code. In one or more embodiments where the network resource has not been modified since a prior virtual copy of the network resource was processed, storing the client-side representation of the network resource includes storing current time information and associating the current time information with the virtual copy of the network resource.

In one or more embodiments, the client-side representation of the network resource is a flattened file. As used herein, the term “flattened file” refers to any representation of an original file that irreversibly combines two or more components of the original file. The components of the virtual copy of the network resource may include text, audio data, image data, video data, scripting language code, metadata, presentation data, and any other associated resource. The client-side representation may be a PDF file, an image file, or any other representation of the virtual copy of the network resource that irreversibly combines two or more components of the virtual copy of the network resource. In one or more embodiments, the client-side representation irreversibly combines all components of the virtual copy of the network resource. The client-side representation may be a screenshot of the network resource as presented to a client accessing the URL.

Processing continues to step 310, where at least one irrelevant data pattern in the virtual copy of the network resource is identified. As used herein, the term “irrelevant data” refers to any data undesirable for comparison or archival purposes in any context. In one or more embodiments, irrelevant data also includes site statistical fields, such as counters and dates. In one or more embodiments, irrelevant data also includes third party data, such as an advertisement, an RSS feed, blog content, a secondary social media feed, social media statistics, or any other third party data. In one or more embodiments, irrelevant data also includes underlying structural information for markup language, scripting language, style sheet languages, source code formatting/comments, or any other underlying structural information. In one or more embodiments, irrelevant data also includes any animation involving source code modification, including but not limited to JavaScript-based animations. In one or more embodiments, irrelevant data also includes any rotating content. In one or more embodiments, irrelevant data also includes unique parameters such as query string parameters, unique session IDs or request IDs, cached dates, user-specific ID information, or any other unique parameters. As used herein, the term “irrelevant data pattern” refers to any identifiable parameter usable to identify any irrelevant data, including but not limited to the irrelevant data described herein.

In one or more embodiments, where an associated resource is of a known type with a unique identifier for each unique resource, the irrelevant data pattern includes the unique identifier, which is usable to determine if the data is undesirable for comparison or archival purposes in the context of archiving only unique data. One example is Youtube™ videos, which can have different MD5 hashes and other changing data associated with the same video. However, the uniqueness of the video can be determined using the unique identifier. In one or more embodiments, in assessing an associated resource of the network resource, if the associated resource is of a known type, at least a portion of data corresponding to the associated resource other than the unique identifier is determined to be irrelevant data. In one or more embodiments, in assessing an associated resource of the network resource, if the associated resource is of a known type, all data corresponding to the associated resource other than the unique identifier is determined to be irrelevant data.

In one or more embodiments, data required for compliance with one or more regulatory bodies is excluded as irrelevant data.

Processing continues to step 312, where the virtual copy is manipulated by applying client-side scripting language code to the virtual copy of the network resource. In one or more embodiments, the client-side scripting language code is applied to remove the irrelevant data associated with the at least one irrelevant data pattern. The client-side scripting language code may be configured to any evaluate the network resource and/or associated resources for any identifiable parameter usable to identify any type of irrelevant data. The client-side scripting language code may also be used to manipulate the virtual copy of the network resource in any other manner.

In one or more embodiments, removing irrelevant data includes determining if the network resource has been modified since a prior virtual copy of the network resource was processed. The representation of the network resource is stored only if the network resource has been modified since the prior virtual copy was modified. Current time information or any other indication that the network resource was checked may be stored and associated with the prior virtual copy of the network resource. In one or more embodiments, determining if the network resource has been modified includes determining if the prior virtual copy of the network resource is identical to the virtual copy of the network resource after the manipulating.

The client-side scripting language code may be applied in a virtual browser. In one or more embodiments, the client-side scripting language code is JavaScript code.

The client-side scripting language code is dynamically obtained. In one or more embodiments, customized client-side scripting language code is obtained or prepared for a third-party with a customized manipulation.

In one or more embodiments, modifications not in compliance with one or more regulatory bodies are prevented. In one or more embodiments, manipulating the virtual copy of the network resource by applying the client-side scripting language code excludes the removal of any data required for compliance with one or more regulatory bodies.

In one or more embodiments, when a resource is of a known type with global presentation data, the resource, other than a content portion of the resource, is considered irrelevant data. The known types may include RSS feeds, social media feeds, social media content, as well as any other group of network resources that may share global presentation data. As used herein, the term “presentation data” refers to any information and/or instructions usable to modify a format of content data. As used herein, the term “content portion” refers to a portion of a network resource that includes content data and excludes at least one piece of global presentation data, such as, but not limited to formatting data applied globally to a set of resources within a domain. A content portion of a network resource may include some presentation data, such as, but not limited to customized presentation data, user-supplied presentation data, additional presentation data applied to content along with at least one piece of global presentation data, or any other presentation data.

In one or more embodiments, manipulating the virtual copy of the network resource by applying the client-side scripting language code includes the steps of identifying at least a section of the virtual copy of the network resource as a predetermined resource type, identifying a presentation portion of the virtual resource section, and identifying a content portion of the virtual resource section. In one or more embodiments, storing the representation of the network resource includes storing the content portion of the virtual resource section without storing the presentation portion of the network resource.

In one or more embodiments, manipulating the virtual copy of the network resource by applying the client-side scripting language code includes the steps of identifying at least a section of the network resource as a social media source, identifying a presentation portion of the section of the network resource, and identifying a content portion of the section of the network resource. In one or more embodiments, storing the representation of the network resource includes storing the content portion of the section of the network resource without storing the presentation portion of the network resource.

Processing continues to optional step 314, where the virtual copy of the network resource is optionally stored. The virtual copy of the network resource may be stored before or after manipulation of the virtual copy of the network resource by applying the client-side scripting language code. In one or more embodiments, the stored virtual copy of the network resource is used to determine if the network resource has been modified since a prior virtual copy of the network resource was processed at an earlier time.

Processing continues to decision step 316, where it is determined whether unprocessed linked URLs are present in the virtual copy. One of ordinary skill in the art would recognize that there are may computer-implemented methods, algorithms and heuristics for determining if an item has been processed, and the use of any method or combination of methods at any point of process 400 will not depart from the spirit and the scope of the invention. In one or more embodiments, determining if a URL is processed includes determining if the URL is associated with a network resource that has been processed, even if the URL is not identical. If unprocessed linked URLs are present, processing continues to step 304. Steps 304-316 are recursively performed to recursively process linked URLs in the original network resource and network resources accessible via the linked URLs.

When no more unprocessed linked URLs are found after the recursive processing, processing continues to step 318, where process 300 terminates.

In one or more embodiments, termination of the recursive process is based on whether the unprocessed linked URL includes one or more specified domain names. The one or more specified domain names may be the domain name included in the first URL of the first network resource. In one or more embodiments, termination of the recursive process is based on a link distance of an unprocessed linked URL from one or more specified domain names.

Although the steps of process 300 are presented in a recited order in the exemplary embodiments pictured in FIG. 3, one of ordinary skill in the art would recognize that the steps may be performed in an order other than presented without departing from the spirit and the scope of the invention.

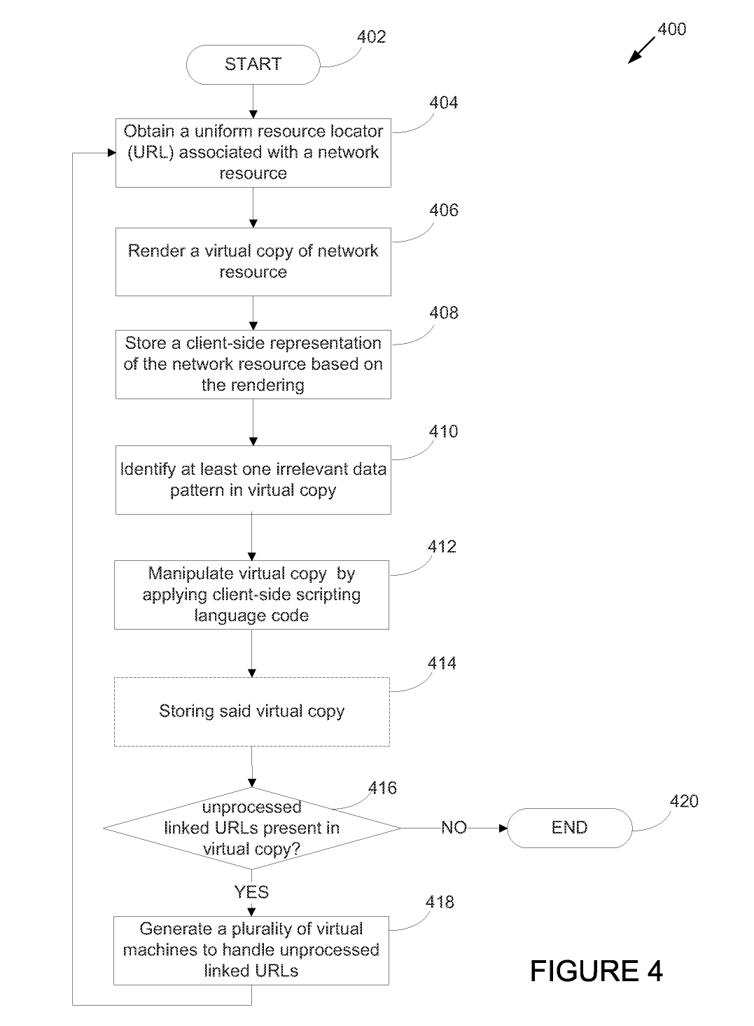

FIG. 4 illustrates an exemplary recursive process using virtual machines in accordance with systems and methods for manipulating and archiving web content. Process 400 starts at step 402.

Processing continues to step 404, where a URL associated with a network resource is obtained. In one or more embodiments, the URL is associated with a webpage accessible over the Internet.

Processing continues to step 406, where a virtual copy of the network resource is rendered. The virtual copy of the network resource is rendered by accessing the network resource and associated resources using the URL. The associated resources may include presentation data, scripting language code, and/or other network resources. In one or more embodiments, rendering the virtual copy of the network resource includes applying any presentation data to render a virtual copy of the network resource, where the rendering is designed to recreate the intended presentation of the network resource to the intended audience accessing the network resource via the URL. The virtual copy of the network resource may be rendered in a virtual browser. The virtual browser may be configured to render the virtual copy of the network resource to recreate the intended presentation of the network resource to the intended audience accessing the network resource via the URL using a browser, such as Microsoft Internet Explorer™, Google Chrome™, Mozilla Firefox™, Apple Safari™, Opera™ or any other web browser, including any general purpose or special purpose browser, such as a microbrowser or wireless Internet browser. For example, the virtual browser may be configured to apply scripting language code, presentation data, integrate associated resources, and any other function to recreate the intended presentation of the network resource to the intended audience accessing the network resource via the URL using a browser.

Processing continues to step 408, where a client-side representation of the network resource based on the rendering is stored. The client-side representation is generated based on the rendered virtual copy of the network resource. In one or more embodiments, the client-side representation is stored before manipulating the virtual copy of the network resource by applying the client-side scripting language code. In one or more embodiments, the client-side representation is stored after manipulating the virtual copy of the network resource by applying the client-side scripting language code. In one or more embodiments, the step of rendering a client-side representation of the network resource includes determining if the network resource has been modified since a prior virtual copy of the network resource as processed. In one or more embodiments, the client-side representation of the network resource is a flattened file. The client-side representation may be a PDF file, an image file, or any other representation of the virtual copy of the network resource that irreversibly combines two or more components of the virtual copy of the network resource. In one or more embodiments, the client-side representation irreversibly combines all components of the virtual copy of the network resource. The client-side representation may be a screenshot of the network resource as presented to a client accessing the URL.

Processing continues to step 410, where at least one irrelevant data pattern in the virtual copy of the network resource is identified. In one or more embodiments, irrelevant data includes site statistical fields, such as counters and dates, advertisements, RSS feeds, blog content, social media feeds, social media statistics, source code formatting/comments, other third party data, underlying structural information for markup language, underlying structural information for a scripting language, underlying structural information for style sheet languages, other underlying structural information, animations involving source code modification, JavaScript-based animations, rotating content, query string parameters, unique session IDs or request IDs, cached dates, user-specific ID information, other unique parameters, or any data undesirable for comparison or archival purposes in any context. In one or more embodiments, data required for compliance with one or more regulatory bodies is excluded as irrelevant data.

Processing continues to step 412, where the virtual copy is manipulated by applying client-side scripting language code. In one or more embodiments, the client-side scripting language code is applied to remove the irrelevant data associated with the at least one irrelevant data pattern. The client-side scripting language code may be configured to any evaluate the network resource and/or associated resources for any identifiable parameter usable to identify any type of irrelevant data. The client-side scripting language code may also be used to manipulate the virtual copy of the network resource in any other manner. The client-side scripting language code may be applied in a virtual browser. In one or more embodiments, the client-side scripting language code is JavaScript code.

In one or more embodiments, removing irrelevant data includes determining if the network resource has been modified since a prior virtual copy of the network resource was processed. The representation of the network resource is stored only if the network resource has been modified since the prior virtual copy was modified. Current time information or any other indication that the network resource was checked may be stored and associated with the prior virtual copy of the network resource. In one or more embodiments, determining if the network resource has been modified includes determining if the prior virtual copy of the network resource is identical to the virtual copy of the network resource after the manipulating.

Processing continues to optional step 414, where the virtual copy of the network resource is optionally stored. The virtual copy of the network resource may be stored before or after manipulation of the virtual copy of the network resource by applying the client-side scripting language code. In one or more embodiments, the stored virtual copy of the network resource is used to determine if the network resource has been modified since a prior virtual copy of the network resource was processed at an earlier time.

Processing continues to decision step 416, where it is determined whether unprocessed linked URLs are present in the virtual copy. One of ordinary skill in the art would recognize that there are may computer-implemented methods, algorithms and heuristics for determining if an item has been processed, and the use of any method or combination of methods at any point of process 300 will not depart from the spirit and the scope of the invention. In one or more embodiments, determining if a URL is processed includes determining if the URL is associated with a network resource that has been processed, even if the URL is not identical.

If unprocessed linked URLs are present, processing continues to step 418, where a plurality of virtual machines are generated to handle unprocessed linked URLs. In one or more embodiments, linked URLs are processed in parallel by the two or more virtual machines. In one or more embodiments, a virtual machine is generated to handle an unprocessed linked URL. After a linked URL is processed by a virtual machine, the virtual machine may wait for another unprocessed linked URL or alternatively terminate. In one or more embodiments, a virtual machine may be assigned multiple URLs to process concurrently, assigned a single URL to process at once, or assigned a plurality of URLs to process in series, or any combination thereof. One or more embodiments employ a plurality of virtual machines in a cloud computing environment. In one or more embodiments, a total number of virtual machines is limited to control a volume of traffic targeted at one or more domains associated with the URL.

Steps 404-416 are recursively performed to recursively process linked URLs in the original network resource and network resources accessible via the linked URLs.

When no more unprocessed linked URLs are found after the recursive processing, processing continues to step 420, where process 400 terminates. Termination of the recursive process may be based on whether the unprocessed linked URL includes one or more specified domain names, such as but not limited to the domain name included in the first URL of the first network resource. In one or more embodiments, termination of the recursive process is based on a link distance of an unprocessed linked URL from one or more specified domain names.

Although the steps of process 400 are presented in a recited order in the exemplary embodiments pictured in FIG. 4, one of ordinary skill in the art would recognize that the steps may be performed in an order other than presented without departing from the spirit and the scope of the invention.

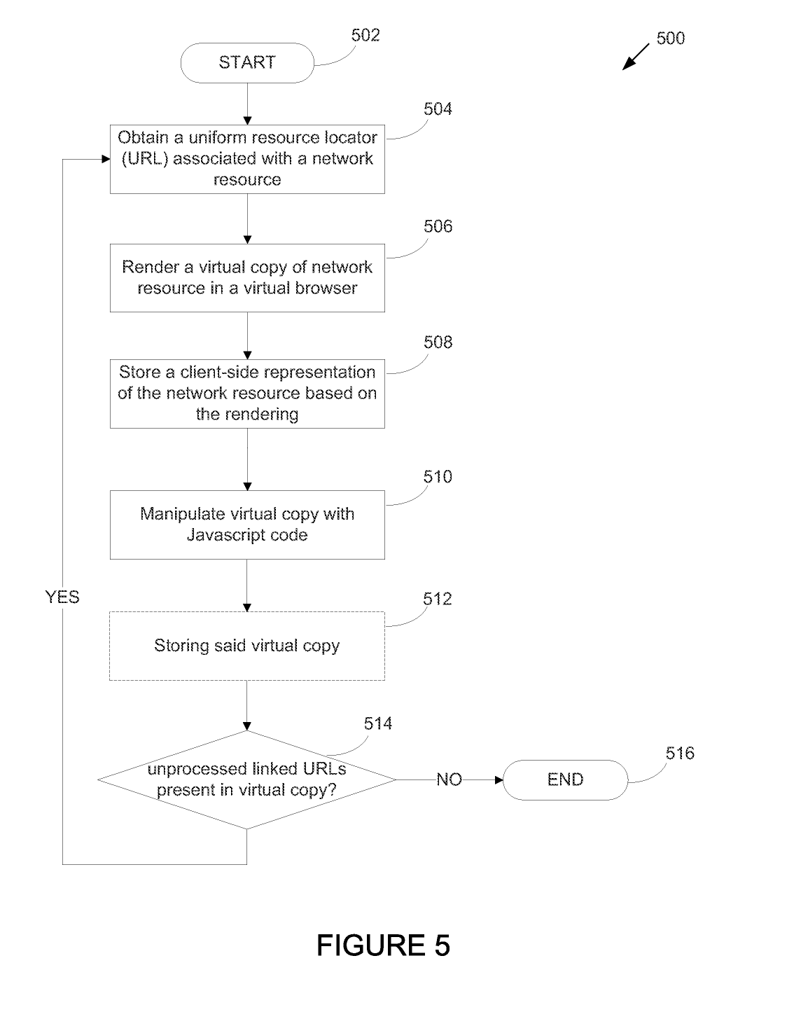

FIG. 5 illustrates an exemplary recursive process involving JavaScript manipulation in accordance with systems and methods for manipulating and archiving web content. Process 500 starts at step 502.

Processing continues to step 504, where a URL associated with a network resource is obtained. In one or more embodiments, the URL is associated with a webpage accessible over the Internet.

Processing continues to step 506, where a virtual copy of the network resource is rendered. The virtual copy of the network resource is rendered in a virtual browser by accessing the network resource and associated resources over a network using the URL. The associated resources may include presentation data, scripting language code, and/or other network resources.

The virtual browser may be configured to render the virtual copy of the network resource to recreate the intended presentation of the network resource to the intended audience accessing the network resource via the URL using a browser, such as Microsoft Internet Explorer™, Google Chrome™, Mozilla Firefox™, Apple Safari™, Opera™ or any other web browser, including any general purpose or special purpose browser, such as a microbrowser or wireless Internet browser. For example, the virtual browser may be configured to apply scripting language code, presentation data, integrate associated resources, and any other function to recreate the intended presentation of the network resource to the intended audience accessing the network resource via the URL using a browser.

Processing continues to step 508, where a client-side representation of the network resource based on the rendering is stored. The client-side representation is based on the rendering of the virtual copy of the network resource in the virtual browser. In one or more embodiments, the client-side representation is stored in a computer-readable storage medium.

In one or more embodiments, the client-side representation is stored before manipulating the virtual copy of the network resource by applying the client-side scripting language code. In one or more embodiments, the client-side representation is stored after manipulating the virtual copy of the network resource by applying the client-side scripting language code. In one or more embodiments, the step of rendering a client-side representation of the network resource includes determining if the network resource has been modified since a prior virtual copy of the network resource as processed.

In one or more embodiments, the client-side representation of the network resource is a flattened file. The client-side representation may be a PDF file, an image file, or any other representation of the virtual copy of the network resource that irreversibly combines two or more components of the virtual copy of the network resource. In one or more embodiments, the client-side representation irreversibly combines all components of the virtual copy of the network resource. The client-side representation may be a screenshot of the network resource as presented to a client accessing the URL.

Processing continues to step 510, where the virtual copy is manipulated in the virtual browser with JavaScript code. The JavaScript code may also be used manipulate the virtual copy of the network resource in any manner. For example, the JavaScript code may be used to manipulate the virtual copy of the network resource to include additional data, to remove selected data, to replace selected data, to modify selected data, or to implement any other customization of the virtual copy of the network resource in the virtual browser.

In one or more embodiments, the JavaScript code is applied to remove the irrelevant data associated with the at least one irrelevant data pattern. The JavaScript code may be configured to any evaluate the network resource and/or associated resources for any identifiable parameter usable to identify any type of irrelevant data. Irrelevant data may include site statistical fields, such as counters and dates, advertisements, RSS feeds, blog content, social media feeds, social media statistics, source code formatting/comments, other third party data, underlying structural information for markup language, underlying structural information for a scripting language, underlying structural information for style sheet languages, other underlying structural information, animations involving source code modification, JavaScript-based animations, rotating content, query string parameters, unique session IDs or request IDs, cached dates, user-specific ID information, other unique parameters, or any data undesirable for comparison or archival purposes in any context. In one or more embodiments, data required for compliance with one or more regulatory bodies is excluded as irrelevant data.

In one or more embodiments, removing irrelevant data includes determining if the network resource has been modified since a prior virtual copy of the network resource was processed. The representation of the network resource is stored only if the network resource has been modified since the prior virtual copy was modified. Current time information or any other indication that the network resource was checked may be stored and associated with the prior virtual copy of the network resource. In one or more embodiments, determining if the network resource has been modified includes determining if the prior virtual copy of the network resource is identical to the virtual copy of the network resource after the manipulating.

Processing continues to optional step 512, where the virtual copy of the network resource is optionally stored. The virtual copy of the network resource may be stored before or after manipulation of the virtual copy of the network resource by applying the JavaScript code in the virtual browser. In one or more embodiments, the stored virtual copy of the network resource is used to determine if the network resource has been modified since a prior virtual copy of the network resource was processed at an earlier time.

Processing continues to decision step 514, where it is determined whether unprocessed linked URLs are present in the virtual copy. One of ordinary skill in the art would recognize that there are may computer-implemented methods, algorithms and heuristics for determining if an item has been processed, and the use of any method or combination of methods at any point of process 500 will not depart from the spirit and the scope of the invention. In one or more embodiments, determining if a URL is processed includes determining if the URL is associated with a network resource that has been processed, even if the URL is not identical.

If unprocessed linked URLs are present, processing continues to step 502. Steps 502-514 are recursively performed to recursively process linked URLs in the original network resource and network resources accessible via the linked URLs where are recursively performed to recursively process linked URLs in the original network resource and network resources accessible via the linked URLs a plurality of virtual machines are generated to handle unprocessed linked URLs. In one or more embodiments, linked URLs are processed in parallel by the two or more virtual machines. In one or more embodiments, a virtual machine is generated to handle an unprocessed linked URL. After a linked URL is processed by a virtual machine, the virtual machine may wait for another unprocessed linked URL or alternatively terminate. In one or more embodiments, a virtual machine may be assigned multiple URLs to process concurrently, assigned a single URL to process at once, or assigned a plurality of URLs to process in series, or any combination thereof. One or more embodiments employ a plurality of virtual machines in a cloud computing environment. In one or more embodiments, a total number of virtual machines is limited to control a volume of traffic targeted at one or more domains associated with the URL.

Steps 504-514 are recursively performed to recursively process linked URLs in the original network resource and network resources accessible via the linked URLs. In one or more embodiments, two or more of the linked URLs are processed in parallel on a plurality of virtual machines. The plurality of virtual machines may be generated and/or accessed in a cloud computing environment.

When no more unprocessed linked URLs are found after the recursive processing, processing continues to step 516, where process 500 terminates. Termination of the recursive process may be based on whether the unprocessed linked URL includes one or more specified domain names, such as but not limited to the domain name included in the first URL of the first network resource. In one or more embodiments, termination of the recursive process is based on a link distance of an unprocessed linked URL from one or more specified domain names.

Although the steps of process 500 are presented in a recited order in the exemplary embodiments pictured in FIG. 5, one of ordinary skill in the art would recognize that the steps may be performed in an order other than presented without departing from the spirit and the scope of the invention.

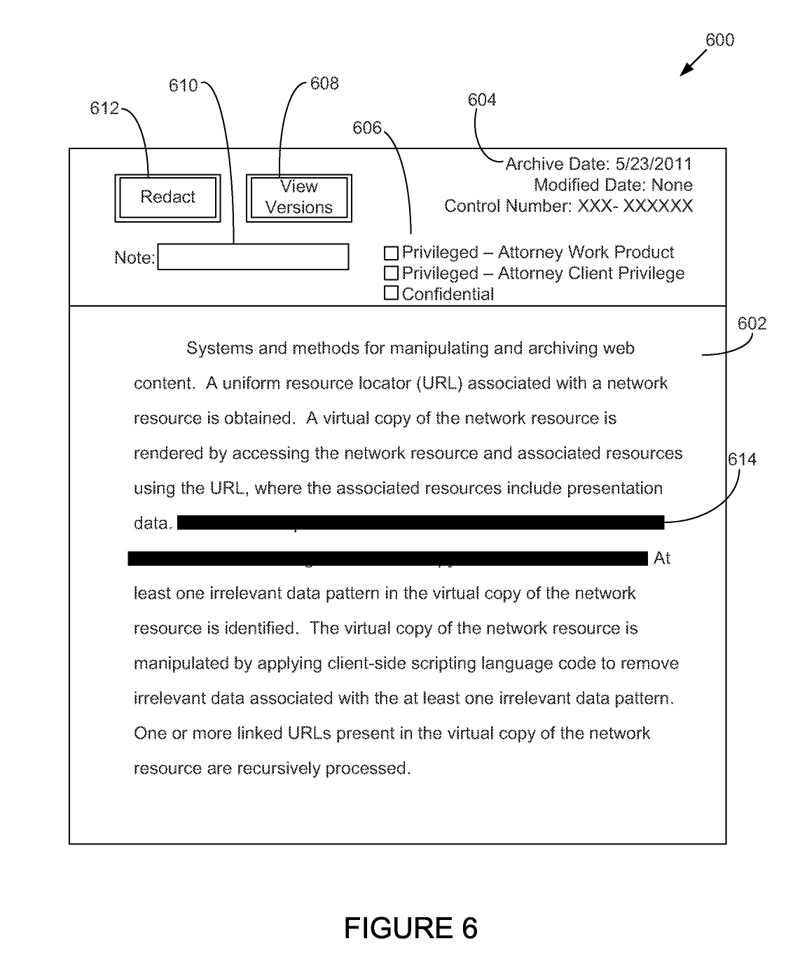

FIG. 6 illustrates an exemplary user interface for displaying stored network resource representations in accordance with systems and methods for manipulating and archiving web content. Document management user interface 600 is configured to display at least one document 602. In one or more embodiments, document 602 is a stored network resource representation. In one or more embodiments, the stored network resource representation is a flattened file that irreversibly combines two or more components of a virtual copy of a network resource. In one or more embodiments, the stored network resource representation irreversibly combines all components of the virtual copy of the network resource. The document may be a PDF file, an image file, or any other representation of a network resource. The document may be a screenshot of a virtual copy of a network resource.

In one or more embodiments, document management user interface 600 is further configured to display document information 604. Document information 604 may include any characteristic of a document, such as document size, file type, archive date, document ID, modification date, document type, URL, domain, or any other information about document 602.

In one or more embodiments, document management user interface 600 is further configured to associate at least one classification 606 with document 602. Classification 606 may allow a single classification or multiple classifications to be selected to associate with document 602. Classification 606 may be selected with checkboxes, radio buttons, checklists, or any other user interface allowing for selection of a classification to associate with document 602. In one or more embodiments, version access interface 608 is configured to display at least one classification 606 associated with document 602. In one or more embodiments, classification 606 includes at least one confidentiality and/or privilege classification associated with e-discovery.

In one or more embodiments, document management user interface 600 includes version access interface 608. Version access interface 608 is configured to display at least one version including one or more modifications made to document 602. In one or more embodiments, modification interface 608 is configured to display one or more versions of document 602 including one or more modifications in compliance with one or more rules and regulations, including but not limited to industry and/or agency regulations.

In one or more embodiments, document management user interface 600 is further configured to associate at least one note 610 with document 602. Note 610 may include any kind of information that may be associated with document 602. In one or more embodiments, version access interface 608 is configured to display at least one note 610 associated with document 602.

In one or more embodiments, document management user interface 600 includes at least one modification interface 612. Modification interface 612 is configured to accept at least one modification to document 602. The at least one modification is stored in association with modification interface 612. In one or more embodiments, modification interface 612 is configured to associate one or more modifications with document 602 in compliance with one or more rules and regulations, including but not limited to industry and/or agency regulations. In one or more embodiments, modification interface 612 is configured to allow a user to add and store one or more redactions 614 to document 602.

While the systems and methods herein disclosed has been described by means of specific embodiments and applications thereof, numerous modifications and variations could be made thereto by those skilled in the art without departing from the scope of the systems and methods set forth in the claims.

What is claimed is:

1. A computer-readable medium for manipulating and archiving web content comprising computer-readable instructions for, wherein execution of said computer-readable instructions by one or more processors causes said one or more processors to carry out steps comprising:
obtaining a uniform resource locator (URL) associated with a network resource;
rendering a virtual copy of said network resource by accessing said network resource and associated resources using said URL, wherein said associated resources comprise presentation data;
storing a client-side representation of said network resource based on said rendering of said virtual copy of said network resource;
identifying at least one irrelevant data pattern in said virtual copy of said network resource;
manipulating said virtual copy of said network resource by applying client-side scripting language code to remove irrelevant data associated with said at least one irrelevant data pattern;
optionally storing said virtual copy of said network resource; and
recursively processing one or more linked URLs present in said virtual copy of said network resource.

2. The computer-readable medium of claim 1, wherein said client-side scripting language code is JavaScript code.

3. The computer-readable medium of claim 1, wherein said virtual copy of said network resource is rendered in a virtual browser.

4. The computer-readable medium of claim 2, wherein said client-side scripting language code is applied in said virtual browser.

5. The computer-readable medium of claim 1, wherein said client-side scripting language code is dynamically obtained.

6. The computer-readable medium of claim 1, wherein said recursively processing one or more linked URLs terminates based on a link distance from one or more specified domain names.

7. The computer-readable medium of claim 1, wherein said client-side representation is stored before applying said client-side scripting language code.

8. The computer-readable medium of claim 1, wherein said client-side representation of said network resource is stored after manipulating said virtual copy of said network resource.

9. The computer-readable medium of claim 1, wherein said client-side representation is a flattened file.

10. The computer-readable medium of claim 1, wherein said client-side representation is screenshot of said network resource as presented to a client accessing said URL.

11. The computer-readable medium of claim 1, wherein said associated resources comprise scripting language code associated with said network resource.

12. The computer-readable medium of claim 1, wherein execution of said computer-readable instructions by one or more processors further causes said one or more processors to carry out steps comprising:
determining if said network resource has been modified since a prior virtual copy of said network resource was processed,
wherein storing said representation of said network resource comprises storing current time information and associating said current time information with said prior virtual copy of said network resource when said network resource has not been modified since said prior virtual copy of said network resource was processed.

13. The computer-readable medium of claim 12, wherein determining if said network resource has been modified comprises determining if said prior virtual copy of said network resource is identical to said virtual copy of said network resource after said manipulating.

14. The computer-readable medium of claim 1, wherein recursively processing said one or more linked URLs comprises processing at least one of said one or more linked URLs on two or more virtual machines.

15. The computer-readable medium of claim 14, wherein said one or more linked URLs are processed in parallel by said two or more virtual machines.

16. The computer-readable medium of claim 14, wherein said two or more virtual machines comprise a plurality of virtual machines in a cloud computing environment.

17. The computer-readable medium of claim 15, wherein a total number of said plurality of virtual machines is limited to control a volume of traffic targeted at one or more domains associated with said URL.

18. The computer-readable medium of claim 1, wherein said manipulating does not remove any data required for compliance with one or more regulatory bodies.

19. The computer-readable medium of claim 1, wherein execution of said computer-readable instructions by one or more processors further causes said one or more processors to carry out steps comprising:
providing a user interface to display one or more stored network resource representations;
accepting at least one modification to said one or more stored network resource representations from a user through said user interface; and
storing said at least one modification in association with said one or more stored network resource representations.

20. The computer-readable medium of claim 19, wherein said at least one modification comprises one or more redactions.

21. The computer-readable medium of claim 19, wherein said at least one modification comprises adding at least one of a classification and a control number.

22. The computer-readable medium of claim 1, wherein execution of said computer-readable instructions by one or more processors further causes said one or more processors to carry out steps comprising:
identifying at least a section of said network resource as a social media source;
identifying a presentation portion of said section of said network resource; and
identifying a content portion of said section of said network resource,
wherein storing said representation of said network resource comprises storing said content portion of said section of said network resource without storing said presentation portion of said network resource.

23. A computer-implemented method for manipulating and archiving web content comprising the steps of:
obtaining a uniform resource locator (URL) associated with a network resource;
rendering a virtual copy of said network resource in a virtual browser by accessing said network resource and associated resources over a network using said URL;
storing a client-side representation of said network resource based on said rendering of said virtual copy of said network resource, wherein said client-side representation is stored in a computer-readable medium;
manipulating said virtual copy of said network resource in said virtual browser with JavaScript code;
optionally storing said virtual copy of said network resource in said computer-readable medium; and
recursively processing one or more linked URLs present in said virtual copy of said network resource.

24. The computer-implemented method of claim 23, wherein said recursively processing said one or more linked URLs comprises processing a plurality of said one or more linked URLs on a plurality of virtual machines in parallel in a cloud computing environment.
